(19) United States
(12) Patent Application Publication
(10) Pub. No.: US 2018/0351445 A1
(43) Pub. Date: Dec. 6, 2018

(54) Self-powered generator

(71) Applicant: Jerry Lewis Moore, Hazlehurst, MS (US)

(72) Inventor: Jerry Lewis Moore, Hazlehurst, MS (US)

(21) Appl. No.: 15/731,375

(22) Filed: Jun. 5, 2017

(51) Int. Cl. H02K 53/00

(52) U.S. Cl. CPC H02K 53/00; F16H 9/04

(57) ABSTRACT

A Self-Powered Generator would be a great improvement over energy sources that are currently being used. It's an unlimited amount of energy with zero input and any amount of energy wanted would be the output. The system is easy to build with three main parts. It uses no oil or fuel to hurt the environment. It could also replace nuclear energy and could make the planet 100 percent clean energy. It would be very helpful in space and space travel. It could be one of the greatest invention ever for clean energy which decreases harm on the environment.

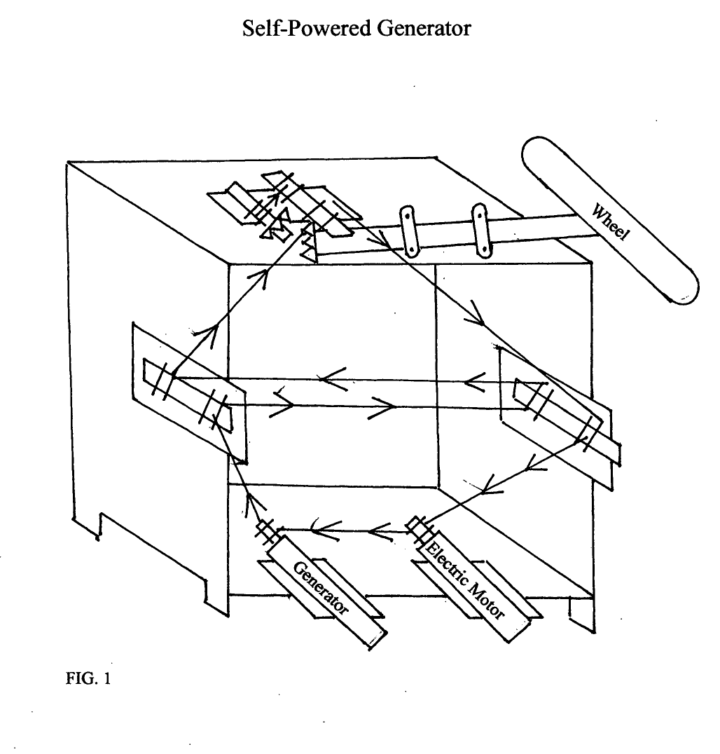

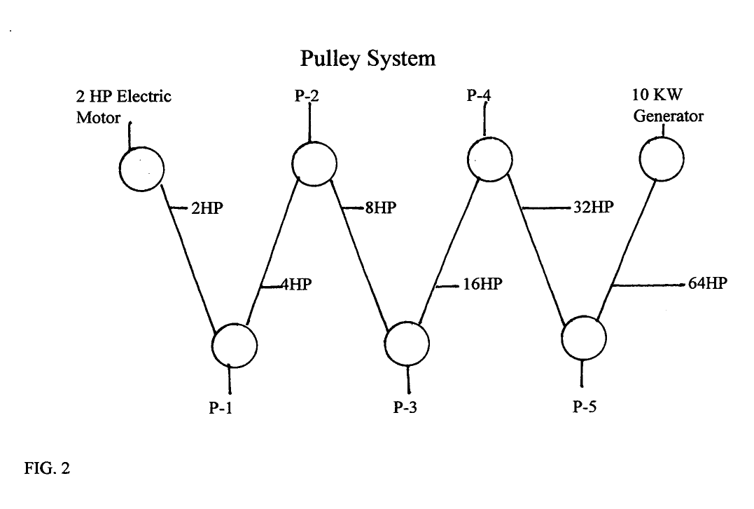

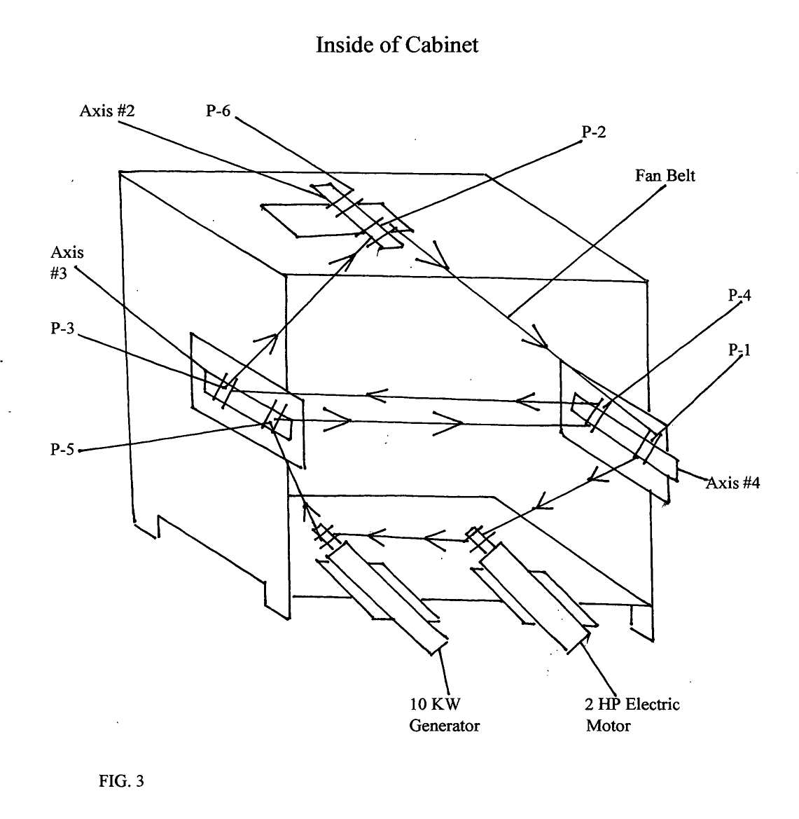

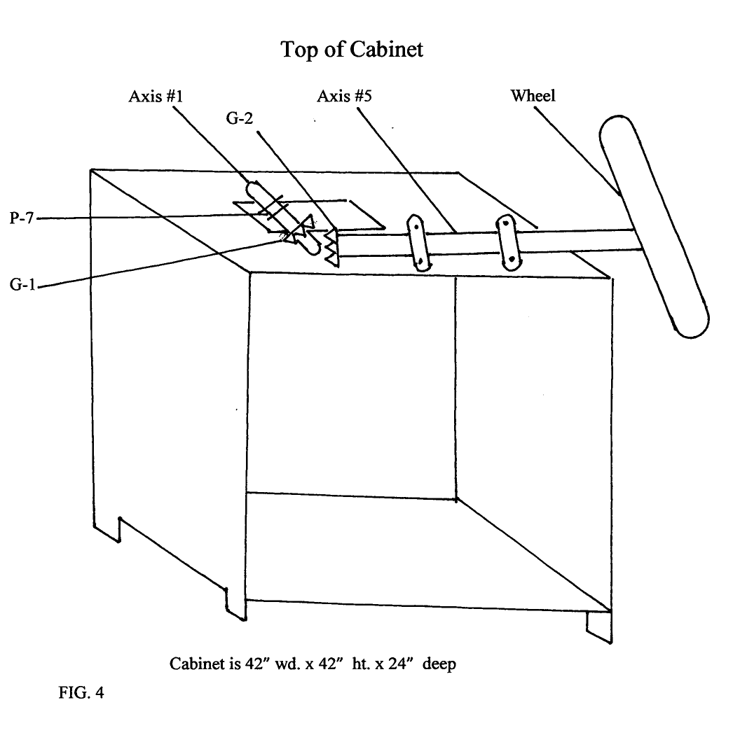

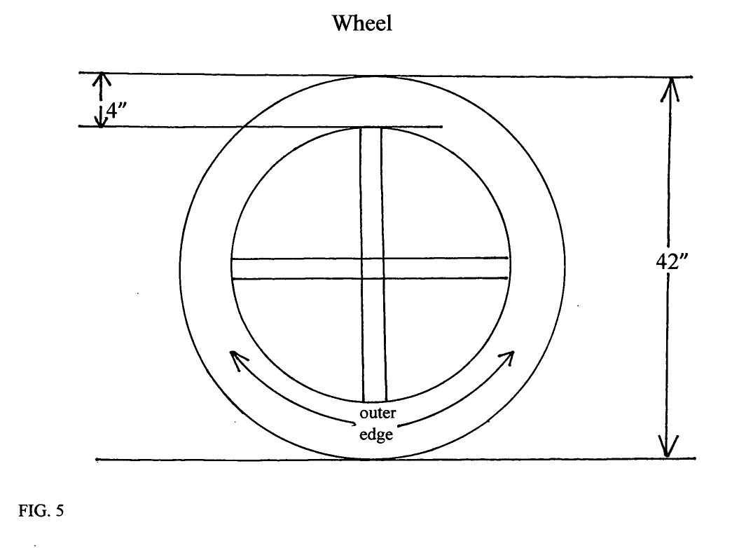

The drawings show the set-up of a self-powered generator. The generator system includes the pulley system, wheel, generator and electric motor. FIG. 1 shows the entire components of the self-powered generator. FIG. 2 is the pulley system which consists of five pulleys and two fan belts. FIG. 3 shows the inner setup of the system. FIG. 4 shows the wheel on top of the cabinet. FIG. 5 is a diagram of the wheel.

(FIG. 1) A self-powered Generator is a generator that runs off it's own power. A wheel weighting a certain amount of weight and rotating at a set RPM is used to store energy for a brief moment for the system to maintain operational speed with added power. In this system (FIG. 2) five pulleys are used. After passing Pulley #1 the pull on Pulley #2 double. (FIG. #3) Starting with a 2 HP electric motor Pulley #2 has 4 HP pulling on it. Also on Pulley #2 a 50 pound wheel is attacked to it. Rotating at 300 RPMs, the wheel is three and a half feet in diameter and 40 pounds of wheel is to the outer edge. With the weight to the outer edge of the wheel, it will free spin longer and add more power to the system. Going to Pulley #3 with 8 HP+WP. Going to Pulley #4 with 16 HP+WP. Going to Pulley #5 with 32 HP+WP. Leaving Pulley #5 and going to the generator with 64 HP+WP and back to the starting point (electric motor).

The electric motor is 2 HP and rotates at 1800 RPMs and requires 120 volts to operate. The 10 KW Generator rotates at 1800 RPMs and requires at least 16 HP to operate properly. It has two 110 volts plugs and one 220 volts plug. Plugging the electric motor into the generator and manually (or other ways) rotating the wheel at 300 RPMs the system will take over and run by itself. The generator will produce 10,000 watts while using 120 for operating and having a surplus of over 9800 watts.

By changing the weight, the speed of the wheel and/or the horsepower of the electric motor, you can have any amount of horsepower that is needed to run any size generator made. No matter how large it is. The pulleys on the generator and motor are 2 inches in diameter rotating at 1800 RPMs. The pulley on P-2 is 4 inches reducing the RPMs to 900. The pulley on P-6 is 2 inches in diameter rotating at 900 RPMs. Pulley #6 is connected to Pulley #7 which is 4 inches rotating at 450 RPMs.

The generator, electric motor, P-1, P-2, P-3, P-4 and P-5 are all connected with one fan belt. P-7 is connected to P-6 with one fan belt. P-7 and G-1 are mounted on axis #1 as in (FIG. 4). P-7 is a 4 inch pulley rotating at 450 RPMs. Also G-1 is a gear with 11 teeth rotating at 450 RPMs. G-2 is a gear attached to the wheel with 16 teeth rotating two third of 450 RPMs which is 300 RPMs. Axis #5 connect G-2 and wheel. In (FIG. 5) the wheel is 42 inches in diameter weighting 50 pounds with 40 pounds 4 inches from the outer edge of the wheel. With the wheel rotating at 300 RPMs it will produce horsepower at the center axis. This horsepower is used as stored energy in motion to keep the system running.

In this system starting at the 2 HP electric motor, it is placed at the beginning of the system for maximum pull power. The pull after Pulley #1 is 4 HP on Pulley #2. Pulley #2 has a wheel attached to it weighting 50 pounds. It is free spinning at 300 RPMs (free-spin means it is not connected with fan belts but with gears making it independent from the rest of the system, providing more power for the system). If system doesn't work, by adding weight, increasing speed of wheel and/or increasing the horsepower of the electric motor will make the system work properly.
WP—wheel pull—the horsepower created at the center axis by the rotating wheel.
P—pulley
G—gear

1. The Self-Powered Generator system will become the main source of energy in the future of the world. It will work from the smallest generator made to the largest generator made. It will be used in all aspects of life: from cooking, heating, cooling, transportation and all things that operate on electricity. It will be a big benefit in space and space travel. The world can go 100 percent clean energy. The system is simple and easy to build.
